(19) United States
(12) Patent Application Publication
(10) Pub. No.: US 2013/0112630 A1
(43) Pub. Date: May 9, 2013

(54) METHODS AND SYSTEMS FOR SEPARATING COMPONENTS OF A SUSPENSION USING A SECONDARY LIQUID

(71) Applicants: Joshua John Nordberg, Bainbridge Island, WA (US); Arturo Bernardo Ramirez, Seattle, WA (US)

(72) Inventors: Joshua John Nordberg, Bainbridge Island, WA (US); Arturo Bernardo Ramirez, Seattle, WA (US)

(21) Appl. No.: 13/398,203

(22) Filed: Feb. 16, 2012

Related U.S. Application Data
(60) Provisional application No. 61/556,882, filed on Nov. 8, 2011.

(51) Int. Cl. B01D 35/00

(52) U.S. Cl. 210/800; 210/513

(57) ABSTRACT

Methods and systems for separating component materials of a suspension are disclosed. In one aspect, a suspension suspected of containing a target material and a secondary fluid are added to a tube. The secondary fluid has a greater density than the suspension, is immiscible in the suspension fluid and is inert with respect to the suspension materials. A float is added to the tube, and the tube, float, suspension and secondary fluid are centrifuged together, with the secondary fluid to occupy the bottom of the tube. The float has a density less than the density of the secondary fluid which enables the float to be suspended within the axially layered materials of the suspension. As a result, the float expands the axial length of the layer containing the target material between the outer surface of the float and the inner surface of the tube.

### CROSS-REFERENCE TO RELATED APPLICATION

This application claims the benefit of Provisional Application No. 61/556,882, filed Nov. 8, 2011.

### TECHNICAL FIELD

This disclosure relates generally to density-based fluid separation and, in particular, to systems and methods for separation and axial expansion of suspension components layered by centrifugation.

### BACKGROUND

Suspensions often include materials of interests that are difficult to detect, extract and isolate for analysis. For instance, whole blood is a suspension of materials in a fluid. The materials include billions of red and white blood cells and platelets in a proteinaceous fluid called plasma. Whole blood is routinely examined for the presence of abnormal organisms or cells, such as ova, fetal cells, endothelial cells, parasites, bacteria, and inflammatory cells, and viruses, including HIV, cytomegalovirus, hepatitis C virus, and Epstein-Barr virus. Currently, practitioners, researchers, and those working with blood samples try to separate, isolate, and extract certain components of a peripheral blood sample for examination. Typical techniques used to analyze a blood sample include the steps of smearing a film of blood on a slide and staining the film in a way that enables certain components to be examined by bright field microscopy.

On the other hand, materials of interest that occur in a suspension with very low concentrations are especially difficult if not impossible to detect and analyze using many existing techniques. Consider, for instance, circulating tumor cells (“CTCs”), which are cancer cells that have detached from a tumor, circulate in the bloodstream, and may be regarded as seeds for subsequent growth of additional tumors (i.e., metastasis) in different tissues. The ability to accurately detect and analyze CTCs is of particular interest to oncologists and cancer researchers. However, CTCs occur in very low numbers in peripheral whole blood samples. For instance, a 7.5 ml sample of peripheral whole blood that contains as few as 5 CTCs is considered clinically relevant for the diagnosis and treatment of a cancer patient. In other words, detecting 1 CTC in a 7.5 ml blood sample is equivalent to detecting 1 CTC in a background of about 10 billion red and white blood cells, which is extremely time consuming, costly and difficult to accomplish using blood film analysis.

As a result, practitioners, researchers, and those working with suspensions continue to seek systems and methods for accurate analysis of suspensions for the presence or absence rare materials of interest.

### SUMMARY

Methods and systems for separating component materials of a suspension are disclosed. In one aspect, a suspension suspected of containing a target material and a secondary fluid are added to a tube. The secondary fluid has a greater density than the suspension, is immiscible in the suspension fluid, and is inert with respect to the suspension materials. A float is added to the tube, and the tube, float, suspension and secondary fluid are centrifuged together causing the various suspension materials to separate into different layers along the long axis of the tube according to the density of each material with the secondary fluid to occupy the bottom of the tube. The float is selected with a density that is less than the density of the secondary fluid and approximately matches the density of the target material. The secondary fluid enables the float to be suspended within the axially layered materials of the suspension. As a result, the float expands the axial length of a layer containing the target material between the outer surface of the float and the inner surface of the tube.

### DESCRIPTION OF THE DRAWINGS

FIGS. 1A-1B show isometric views of two example tube and float systems.

FIG. 2 shows an isometric view of the example float of the tube and float system shown in FIG. 1.

FIGS. 3-5 show examples of different types of floats.

FIGS. 6A-6C show use of an example tube and float system with a secondary fluid.

FIGS. 7A-7B show an example tube of a tube and float system with a secondary fluid added.

FIG. 8 shows an example of a centrifuged tube and float system with a secondary fluid.

FIG. 9 shows an example of a centrifuged tube and float system with a secondary fluid.

### DETAILED DESCRIPTION

Methods and systems for separating component materials of a suspension are disclosed. The detailed description is organized into two subsections: (1) A general description of various tube and float systems is provided in a first subsections. (2) Examples of methods and systems for separating component materials of suspensions using tube and float systems are provided in a second subsection.

### Tube and Float Systems

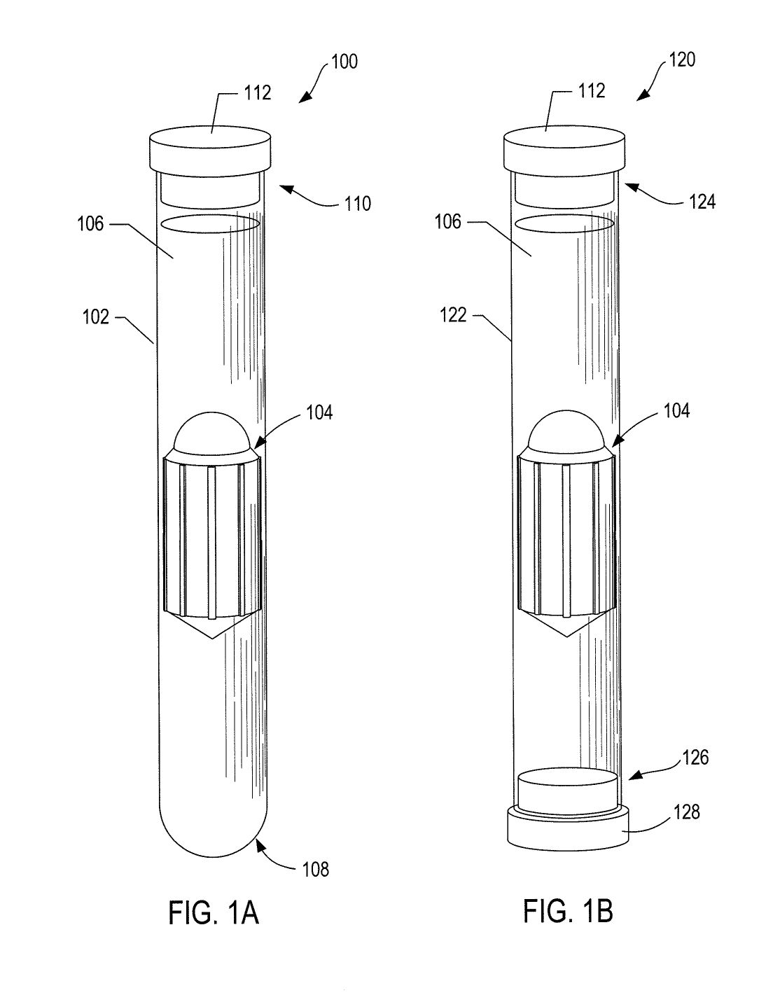

FIG. 1A shows an isometric view of an example tube and float system 100. The system 100 includes a tube 102 and a float 104 suspended within a suspension 106. In the example of FIG. 1A, the tube 102 has a circular cross-section, a first closed end 108, and a second open end 110. The open end 110 is sized to receive a stopper or cap 112. The tube may also have two open ends that are sized to receive stoppers or caps, such as the example tube and float system 120 shown FIG. 1B. The system 120 is similar to the system 100 except the tube 102 is replaced by a tube 122 that includes two open ends 124 and 126 configured to receive the cap 112 and a cap 128, respectively. The tubes 102 and 122 have a generally cylindrical geometry, but may also have a tapered geometry that widens toward the open ends 110 and 124, respectively. Although the tubes 102 and 122 have a circular cross-section, in other embodiments, the tubes 102 and 122 can have elliptical, square, triangular, rectangular, octagonal, or any other suitable cross-sectional shape that substantially extends the length of the tube. The tubes 102 and 122 can be composed of a transparent or semitransparent flexible material, such as flexible plastic or another suitable material.

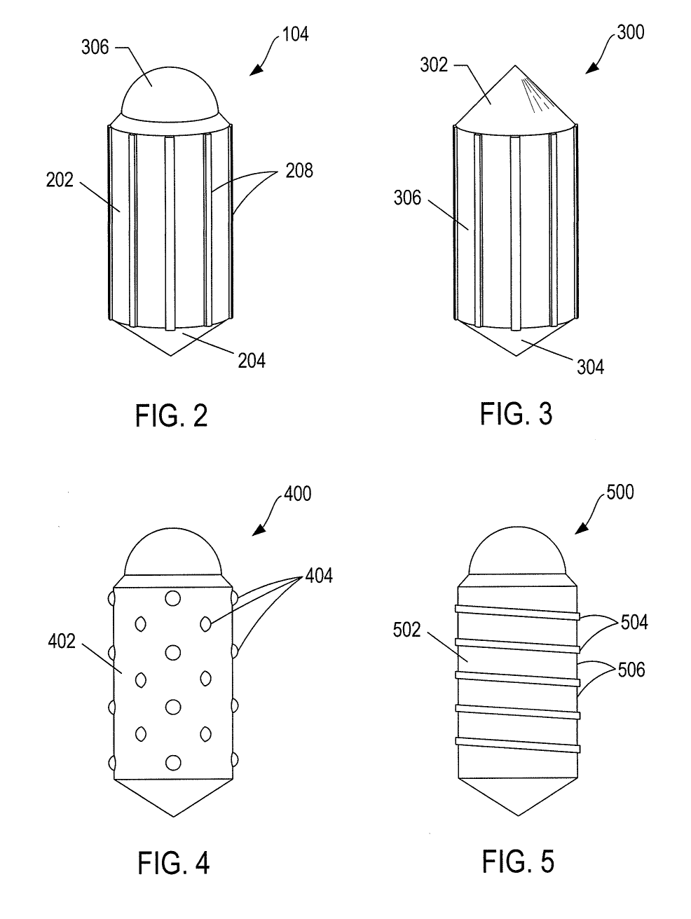

FIG. 2 shows an isometric view of the float 104 shown in FIG. 1. The float 104 includes a main body 202, a cone-shaped tapered end 204, a dome-shaped end 206, and splines 208 radially spaced and axially oriented on the main body 202. The splines 208 provide a sealing engagement with the inner wall of the tube 102. In alternative embodiments, the number of splines, spline spacing, and spline thickness can each be independently varied. The splines 208 can also be broken or segmented. The main body 202 is sized to have an outer diameter that is less than the inner diameter of the tube 102, thereby defining fluid retention channels between the outer surface of the body 202 and the inner wall of the tube 102. The surfaces of the main body 202 between the splines 208 can be flat, curved or have another suitable geometry. In the example of FIG. 2, the splines 208 and the main body 202 form a single structure.

Embodiments include other types of geometric shapes for float end caps. FIG. 3 shows an isometric view of an example float 300 with two cone-shaped end caps 302 and 304. The main body 306 of the float 300 includes the same structural elements (i.e., splines and bore holes) as the float 104. A float can also include two dome-shaped end caps. The float end caps can include other geometric shapes and are not intended to be limited the shapes described herein.

In other embodiments, the main body of the float 104 can include a variety of different support structures for separating target materials, supporting the tube wall, or directing the suspension fluid around the float during centrifugation. FIGS. 4 and 5 show examples of two different types of main body structural elements. Embodiments are not intended to be limited to these two examples. In FIG. 4, the main body 402 of a float 400 is similar to the float 104 except the main body 402 includes a number of protrusions 404 that provide support for the deformable tube. In alternative embodiments, the number and pattern of protrusions can be varied. In FIG. 5, the main body 502 of a float 500 includes a single continuous helical structure or ridge 504 that spirals around the main body 502 creating a helical channel 506. In other embodiments, the helical ridge 504 can be rounded or broken or segmented to allow fluid to flow between adjacent turns of the helical ridge 504. In various embodiments, the helical ridge spacing and rib thickness can be independently varied.

The float can be composed of a variety of different materials including, but are not limited to, rigid organic or inorganic materials, and rigid plastic materials, such as polyoxymethylene (“Delrin®”), polystyrene, acrylonitrile butadiene styrene (“ABS”) copolymers, aromatic polycarbonates, aromatic polyesters, carboxymethylcellulose, ethyl cellulose, ethylene vinyl acetate copolymers, nylon, polyacetals, polyacetates, polyacrylonitrile and other nitrile resins, polyacrylonitrile-vinyl chloride copolymer, polyamides, aromatic polyamides (“aramids”), polyamide-imide, polyarylates, polyarylene oxides, polyarylene sulfides, polyarylsulfones, polybenzimidazole, polybutylene terephthalate, polycarbonates, polyester, polyester imides, polyether sulfones, polyetherimides, polyetherketones, polyetheretherketones, polyethylene terephthalate, polyimides, polymethacrylate, polyolefins (e.g., polyethylene, polypropylene), polyallomers, polyoxadiazole, polyparaxylene, polyphenylene oxides (“PPO”), modified PPOs, polystyrene, polysulfone, fluorine containing polymer such as polytetrafluoroethylene, polyurethane, polyvinyl acetate, polyvinyl alcohol, polyvinyl halides such as polyvinyl chloride, polyvinyl chloride-vinyl acetate copolymer, polyvinyl pyrrolidone, polyvinylidene chloride, specialty polymers, polystyrene, polycarbonate, polypropylene, acrylonitrite butadiene-styrene copolymer and others.

### Examples of Methods and Systems for Separating Components of a Suspension

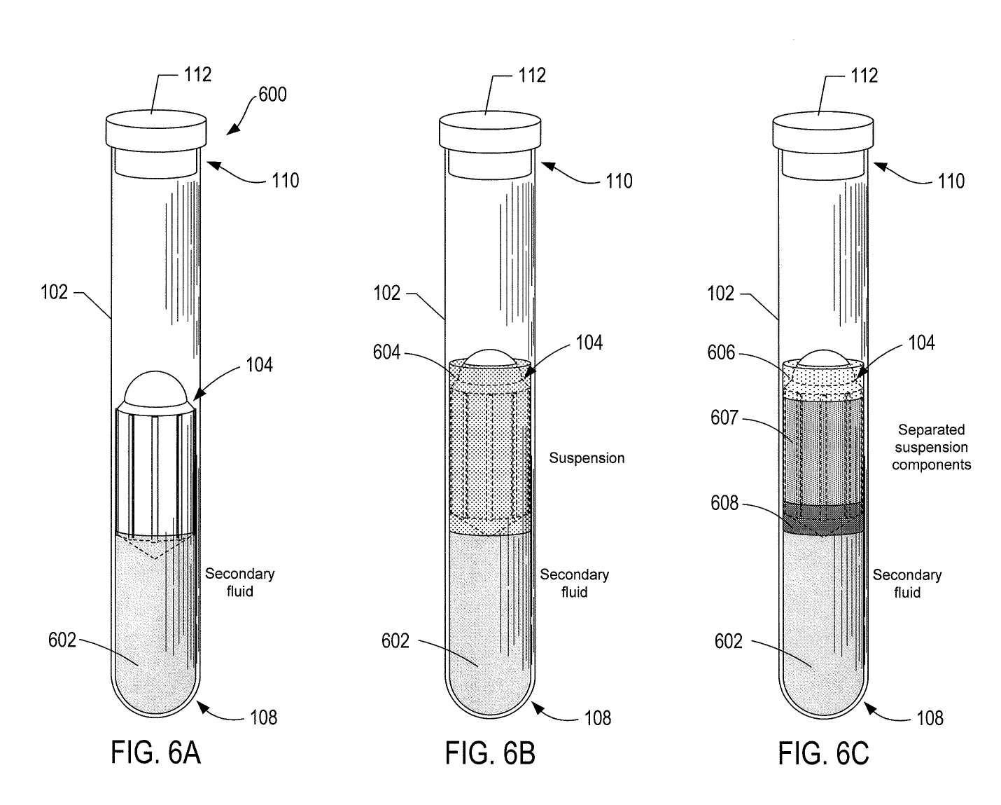

FIG. 6A shows an example of a system 600 for separating component materials of a suspension according to associated material densities. The system 600 includes the tube and float system 100, as described above with reference to FIG. 1A, and includes a secondary fluid 602 placed in the bottom of the tube 102. The fluid 602 is a liquid substance that has a greater density than the density of the float 104 and has viscosity less than about 500 centistokes at about 25° C. As a result, the float 104 rests on the surface of the fluid 602 or, as shown in FIG. 6A, only a small portion of the float enters the top of the fluid 602. In other words, the composition of the fluid 602 is selected so that the float 104 does not sink an appreciably amount into the fluid 602.

FIG. 6B shows the system 600 with an example suspension 604 added to the tube 102. The suspension 604 can be a heterogeneous fluid composed of a number of different solid materials in the form of particles suspended within a suspension fluid. In addition to the fluid 602 having a density greater than that of the float 104, the fluid 602 also has a greater density than the densities associated with the component materials of the suspension 604 and has a greater density than the suspension fluid. The composition of the fluid 602 is selected so that the fluid 602 is immiscible in the suspension fluid and is inert with respect to the suspension materials. One or more of the materials can be the subject of analysis and is referred to as a “target material.” The float 104 is configured to have approximately the same density as the target material. As a result, the float 104 is suspended within the suspension 604 above the fluid 602.

In order to separate and isolate the target material from other materials in the suspension 604, the tube, float, suspension, and secondary fluid shown in FIG. 6B are centrifuged together for a period of time. Centrifugation creates centrifugal forces that cause the materials of the suspension to separate into layers along the long axis of the tube 102. The material layers are separated and layered according to their associated densities ranging from the highest density material located on the fluid 602 to the lowest density material located farthest away from the fluid 602. Because the fluid 602 is immiscible in the suspension fluid, the fluid 602 does not mix with the suspension fluid, which prevents a change in the density of both fluids and prevents a change in the density gradient within the layered suspension materials.

Suppose, for example, that the suspension 604 is composed of three component materials. FIG. 6C shows the tube and float system 600 after centrifugation with the three component materials of the suspension 604 separated along the long axis of the tube into three layers 606-608. The layer 608 contains the highest density materials that occupy the region directly above the fluid 602, and the layer 606 contains the lowest density materials that occupy the region around the top of the float 104. The intermediate layer 607 contains the target material, which has a density between the lowest and highest density materials. Note that in the example of FIG. 6C, the float 104 is selected with a density that approximately matches the density of the target material. The density of the fluid 602 ensures that the float 104 stays suspended within the suspension 604 during centrifugation. In other words, as the materials separate, the main body of the float 104 is axially positioned to approximately match the position of the target material. As a result, the float 104 spreads the layer 607 so that the target material lies in the narrow region between the main body of the float 104 and the inner wall of the tube 102.

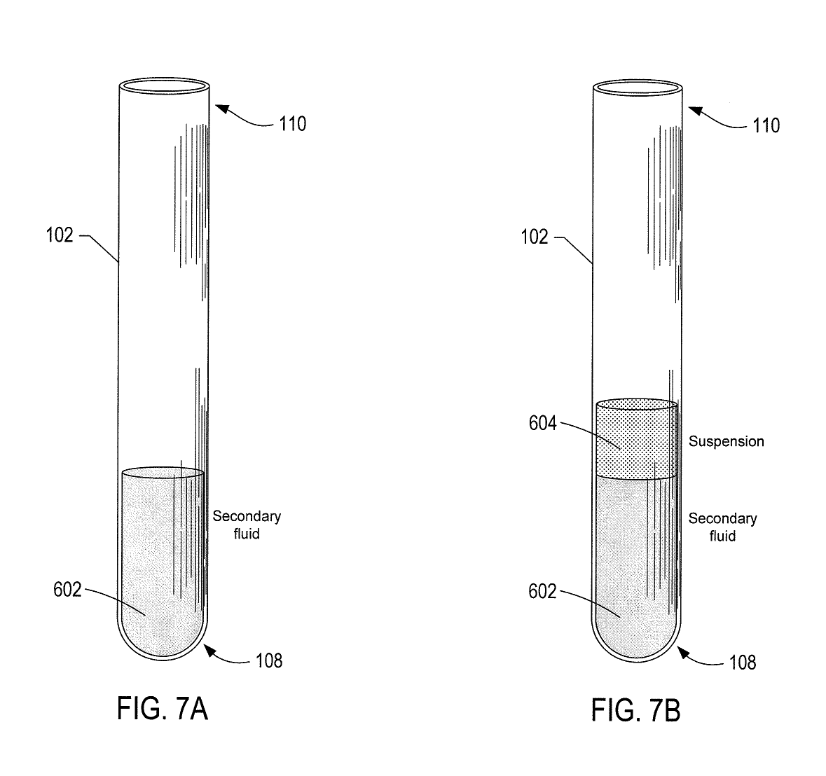

In other embodiments, the suspension can be added to the tube prior to adding the float. FIG. 7A shows an example of the tube 102 with the secondary fluid 602 located in the bottom of the tube 102. FIG. 7B shows the tube 102 at a later time with the suspension 604 added to the tube 102. As described above, the fluid 602 has a greater density than the suspension materials and the suspension fluid and the fluid 602 is immiscible with the suspension fluid and inert with respect the suspension component materials. As a result, the suspension 604 floats or rests on top of, and does not mix with, the fluid 602. The float 104 can then be added to the tube 102 and the contents centrifuged to separate the component materials into layers along the long axis of the tube 102, as described above with reference to FIGS. 6B and 6C.

Methods and systems can be used with a variety of different suspensions. In particular, methods and systems can be used with suspensions that are biological fluid samples. Examples of biological fluid samples include, but are not limited to, such as blood, stool, semen, cerebrospinal fluid, nipple aspirate fluid, saliva, amniotic fluid, vaginal secretions, mucus membrane secretions, aqueous humor, vitreous humor, vomit, and any other physiological fluid or semi-solid. The secondary fluid is immiscible in water, is inert with respect to the biological component materials of the sample. Examples of suitable secondary fluids include, but are not limited to, perfluoroketones, such as perfluorocyclopentanone and perfluorocyclohexanone, fluorinated ketones, hydrofluoroethers, hydrofluorocarbons, perfluorocarbons, perfluoropolyethers, silicon and silicon-based liquids, such as phenylmethyl siloxane. For biological fluid samples, the secondary fluid can be phenylmethyl siloxane with a density greater than about 1.09 g/ml and the float has a density in the range of about 1.0 to about 2.0 g/ml.

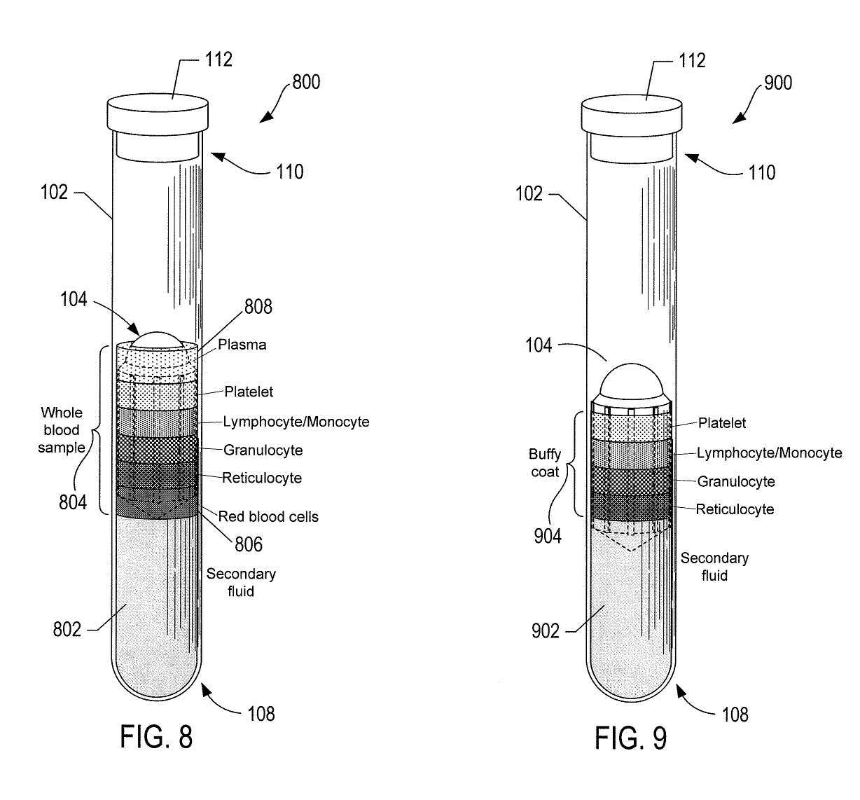

FIG. 8 shows an example of a centrifuged system 800 with a secondary fluid 802 located in the bottom of the tube 102. The tube 102 also includes a whole blood sample 804 that after centrifugation is separated into six layers: (1) packed red cells, (2) reticulocytes, (3) granulocytes, (4) lymphocytes/monocytes, (5) platelets, and (6) plasma. The reticulocyte, granulocyte, lymphocytes/monocyte, platelet layers form the buffy coat and are the layers often analyzed to detect certain abnormalities and cancer. When the suspension is blood sample, such as the sample shown in FIG. 8, the float 104 can have density of about 1.05 g/mL, and the fluid 802 selected has a viscosity less than about 15 centistokes and a density greater than about 1.679 g/ml. As shown in FIG. 8, the blood sample components are separated axially within the tube 102 into layers according to their associated densities ranging from the highest density material, red blood cells 806, located on the fluid 802 to the lowest density material, plasma 808, located farthest away from the fluid 802. Without the float 104, the layers comprising the buffy coat are thin and can be difficult to extract for analysis. But, as shown in the example of FIG. 8, the float 104 expands the buffy coat between the main body of the float 104 and the inner wall of tube 102, which enables the buffy coat layers and associated materials to be analyzed through the tube 102 wall. Because the fluid 802 is immiscible in water and has a greater density than water, the fluid 802 does not combine with the buffy coat layers. In addition, because the fluid 802 has a greater density than the float 104, the fluid 802 fills the space between the bottom of the tube 102 and float 104. As a result, the float 104 stays suspended with the sample 804.

In order to identify and determine the presence of a target material in a suspension, target material particles can be tagged with fluorescent markers. After centrifugation, the tube is illuminated with light that induces photon emission from the fluorescent markers. The fluorescent light can be used to confirm the presence and identity of the target material. For example, target material particles can be certain types of cells, such as CTCs, vesicles, liposomes, or a naturally occurring or artificially prepared microscopic unit having an enclosed membrane. The fluorescent molecules are conjugated with molecules or other particles that bind specifically to the target material particles. The fluorescent molecules emit light within a known range of wavelengths, depending of the particular fluorescent molecule when an appropriate stimulus is applied. As described above, the float has a density selected to position the float at approximately the same level as the target particles when the tube, float, secondary fluid and suspension are centrifuged together. After centrifugation, the target particles are located between the outer surface of the float and the inner wall of the tube and the fluorescent molecules fluoresce when an appropriate stimulus is applied. In order to prevent the secondary fluid from interfering with fluorescence from the fluorescent molecules, the secondary fluid selected does not fluoresce when exposed to the stimulus and is inert with respect to the fluorescent molecule.

Tube and float systems that include a secondary fluid allow for small suspension volumes to be analyzed in the same manner in which much larger volumes of the suspension are analyzed using the tube and float system without the secondary fluid. FIG. 9 shows an example of a centrifuged tube and float system 900 with a secondary fluid 902 located in the bottom of the tube 102. In this example, the suspension under analysis is a buffy coat 904, which includes a very low volume biological sample. As shown in the example of FIG. 9, the fluid 902 fills the space between the bottom of the tube 102 and the float 104 so that the buffy coat layers can be separated and spread between the main body of the float 104 and the inner wall of the tube 102 during centrifugation. In this example, the density of the float 104 is greater than about 1.090 g/mL, being approximately 1.21 g/mL. In other words, the secondary fluid can be used to add volume to the tube so that very small volume suspensions can be centrifuged and analyzed in the same manner larger volume suspensions are centrifuged and analyzed.

In addition, because the secondary fluid is immiscible in water and does not react with the suspension component materials, the secondary fluid enables intracellular protein analysis without concern for changes in the density properties of blood components. The techniques for intracellular protein analysis include intracellular protein staining, fluorescent in situ hybridization, or branched DNA (i.e., “bDNA”—a tool for analyzing mRNA expression levels) analysis. These techniques are aided by isolation and fixation of the target cells prior to analysis. However, the secondary fluid allows cells to localize to the float surface after fixing and permeabilizing the cells, which otherwise disrupts their density properties. Some of the intracellular proteins which may be stained include, but are not limited to, cytokeratin (“CK”), actin, Arp2/3, coronin, dystrophin, FtsZ, myosin, spectrin, tubulin, collagen, cathepsin D, ALDH, TWIST1, PBGD, and MAGE. For example, CK staining can be used in the identification and enumeration of CTCs in a blood sample and subsequent diagnosis of various cellular events.

The foregoing description, for purposes of explanation, used specific nomenclature to provide a thorough understanding of the disclosure. However, it will be apparent to one skilled in the art that the specific details are not required in order to practice the systems and methods described herein. For example, methods and systems described above are not intended to be limited to used of the tube and float system 100 represented in FIG. 1A. Method embodiments can be carried in the same manner using the tube and float system 120 shown in FIG. 1B. The foregoing descriptions of specific embodiments are presented by way of examples for purposes of illustration and description. They are not intended to be exhaustive of or to limit this disclosure to the precise forms described. Obviously, many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

1. A system for separating component materials of a suspension, the system comprising:
a tube having an open end to receive the suspension;
a float to be inserted within the tube, the float to have a density that approximately matches a density of a target material of the suspension; and
a secondary fluid to be placed in the tube, the secondary fluid to have a greater density than the float and a greater density than the suspension.

2. The system of claim 1, wherein the suspension includes a suspension fluid and the secondary fluid to be immiscible in the suspension fluid.

3. The system of claim 1, wherein the secondary fluid to be inert with respect to the suspension component materials.

4. The system of claim 1, further comprising the target material labeled with fluorescent molecules, the secondary fluid to not fluoresce when exposed to a stimulus that stimulates fluoresce of the fluorescent molecules and the secondary fluid to be inert with respect to the fluorescent molecules.

5. The system of claim 1, wherein the secondary fluid further comprises one or more of perfluoroketones, fluorinated ketones, hydrofluoroethers, hydrofluorocarbons, perfluorocarbons, and perfluoropolyethers.

6. The system of claim 1, wherein the secondary liquid further comprises one of a silicon liquid and silicon-based liquids.

7. The system claim 1, wherein the secondary liquid is phenylmethyl siloxane having a density greater than 1.090 g/mL.

8. The system of claim 1, wherein the secondary liquid has a viscosity less than 501 centistokes.

9. The system of claim 1, wherein the float has a density of about 1.0-2.0 g/mL.

10. The system of claim 1, wherein the secondary liquid has a density greater than about 1.090 g/mL.

11. A method for separating component materials of a suspension, the method comprising:
adding a secondary fluid to a tube;
inserting a float into the tube, the float having a density less than a density of the secondary fluid;
adding the suspension to the tube, the suspension having a density less than the density of the secondary fluid; and
separating suspension materials into different layers along a long axis of the tube to isolate a target material between the float and the tube, wherein the secondary fluid fills a space between a bottom of the float and a bottom of the tube.

12. The method of claim 11, wherein separating suspension materials into different layers along the long axis of the tube further comprises centrifuging the tube, float, secondary fluid and suspension.

13. The method of claim 11, wherein the float has a density that approximately matches a density of a target material of the suspension.

14. The method of claim 11 further comprising applying a stimulus to stimulate fluorescence from fluorescently label target materials of the suspension, wherein the secondary fluid does not fluoresce when exposed to the stimulus and is inert with respect to the fluorescent molecules.

15. The method of claim 11, wherein the suspension includes a suspension fluid and the secondary fluid to be immiscible in the suspension fluid.

16. The method of claim 11, wherein the secondary fluid to be inert with respect to the suspension component materials.

17. The method of claim 11, wherein the secondary fluid further comprises one or more of perfluoroketones, fluorinated ketones, hydrofluoroethers, hydrofluorocarbons, perfluorocarbons, and perfluoropolyethers.

18. The method of claim 11, wherein the secondary liquid further comprises one of a silicon liquid and silicon-based liquids.

19. The method claim 11, wherein the secondary fluid is phenylmethyl siloxane having a density greater than 1.090 g/mL.

20. The method of claim 11, wherein the secondary fluid has a viscosity less than 501 centistokes.

21. The method of claim 11, wherein the float has a density from about 1.0-2.0 g/mL.

22. The method of claim 11, wherein the secondary liquid has a density greater than about 1.090 g/mL.
